(19) United States
(12) Patent Application Publication
(10) Pub. No.: US 2013/0202488 A1
(43) Pub. Date: Aug. 8, 2013

(54) OPTICAL EVANESCENT FIELD SENSOR

(71) Applicants: Gregor Langer, Wolfnitz (AT); Hannes Voraberger, Graz (AT)

(72) Inventors: Gregor Langer, Wolfnitz (AT); Hannes Voraberger, Graz (AT)

(21) Appl. No.: 13/879,260

(22) PCT Filed: Oct. 14, 2011
(86) PCT No.: PCT/AT11/00428

§ 371 Date: Apr. 12, 2013

(30) Foreign Application Priority Data
Oct. 14, 2010 (AT) GM 635/2010

(51) Int. Cl. G01N 21/41

(52) U.S. Cl. CPC G01N 21/41
USPC 422/69; 29/428

(57) ABSTRACT

The invention relates to an optical sensor device (1) comprising a substrate (2) on which at least one light source (4), such as an LED, is arranged, from which at least one optical waveguide (7) leads to at least one receiver (5), such as a photodiode, to which an evaluating unit (6) is connected, wherein the optical waveguide (7) is accessible in a sensor region (8) for a change of the evanescent field of the optical waveguide present there; an optical layer (3) made of material that can be photopolymerized is applied to the substrate (2), wherein the optical waveguide (7) is structured by an exposure process in said optical layer, wherein the optical waveguide (7) is led to the surface (9) of the optical layer (3) in the sensor region (8).

### FIELD OF THE INVENTION

The invention relates to an optical sensor device comprising a substrate on which at least one light source, such as an LED, is arranged, from which at least one optical waveguide leads to at least one receiver, such as a photodiode, wherein the optical waveguide is accessible in a sensor region for a change of its evanescence field present there.

### BACKGROUND OF THE INVENTION

From DE 10 2005 021 008 A1 there is known such a sensor device in the form of an optical switch or touch-button, wherein the disturbance of an evanescent field of an optical waveguide is utilized to carry out a switching function. The optical waveguide extends between a light emitter, i.e. a light source, and a sensor or receiver, connected to which is an evaluating unit, and it is accessible in the region of a contact surface. Normally, when not being touched, there occurs a light reflection on the surface of the optical waveguide. Upon touching this surface, the evanescent field propagating in this region and thus the light propagation will be disturbed. This leads to signal weakening, which is evaluated as switching signal. In the sensor region (touch field), the optical waveguide need not necessarily be actually touched or pressed for the switching function to be achieved; approaching the surface of the optical waveguide with an object, such as a finger, is also sufficient to cause the desired weakening of intensity. A disadvantage of this known switch or touch-button is, among others, that it is composed of individual, discrete components, which results in a costly and large constructional unit, which is difficult to manufacture and little stable, wherein, in particular, the application of the optical waveguide is problematic.

The DE 10 350 526 A describes the structure and mode of functioning of a bio- and chemosensor. Said known bio- and chemosensor, however, comprises an optical multi-layer structure having at least two layers for realizing a waveguide; in addition, separate coupling elements for coupling the optical radiation between the opto-electronic components and the waveguide are required.

Moreover, from AT 406 711 B there is known a method for the spectroscopic determination of the alcohol concentration in liquid samples, wherein the change of intensity of specific wavelengths can be detected by the absorption capacity of the analyte used in the absorption measurement.

In general, bio- or chemosensors are referred to as devices that are able to detect an analyte in terms of quality or quantity with the help of a signal converter and a recognition reaction.

In general, the specific binding or reaction of an analyte with a recognition element is called recognition reaction. Examples of recognition reactions are the bonding of ligands to complexes, the complexation of ions, the binding of ligands to receptors, membrane receptors or ion channels, of antigens or haptens to antibodies, of substances to enzymes and so on.

In addition, special analytes (e. g. gases or liquids such as ethanol, CFCs . . . ) can be detected directly by detecting intensities of specific wavelengths of the absorption spectrum of the analyte (e. g. alcohol).

These bio- or chemosensors can be used in environmental analysis, in the food sector, in human and veterinary diagnostics and in plant protection, so as to determine analytes in terms of quality and/or quantity.

On the other hand, tactile sensors of the type of interest here are optical sensors detecting any touching of the sensor surface. When the detection signal is recognized and further processed, e.g. when another function is performed, the tactile sensor is part of a switch. Such an optical tracer or switch has considerable advantages due as it does not carry any current. Thus, it is particularly appropriate to use such a switch in highly sensitive regions, in which a good electromagnetic compatibility is important, that is to say in which, if possible, no electromagnetic fields such as automatically occurring in a power line are desirable. The optical sensor and feeler could also be used in potentially explosive atmospheres, since it cannot produce sparks due to its current-less operating principle. In addition, the optical construction does not require any mechanically movable components, which makes it insusceptible to wear and almost maintenance-free.

The optical sensor devices described herein work according to the principle of influencing the evanescent field of an optical waveguide.

Optical waveguides constitute a class of signal converters by means of which it is possible to detect the change of the optical properties of a medium adjoining a wave-guiding layer. If light is transported in the wave-guiding layer as guided mode, the light field does not drop abruptly on the boundary of medium/waveguide, but fades exponentially in the so-called detection medium adjoining the waveguide. Said exponentially decreasing light field is called evanescent field. A change of the optical properties of the medium adjoining the waveguide (e. g. change in the optical refractive index, the luminescence, the absorption) within the evanescent field may be detected by means of a suitable measuring set-up. The decisive factor for the use of waveguides as signal converters in bio-, chemo- or tactile sensors is that the change of the optical properties of the medium is detected only very close to the surface of the optical waveguide.

The main problem of such a sensor device is a compact integrated optical waveguide system wherein the light source, the light sensor and the optical waveguide are present; in addition, the optical waveguide must be designed in three dimensions, since it should be led to the surface of the sensor field.

So far, the light-transmitting elements have, as mentioned, been realized either by fibre technology (glass fibres or polymer fibres), which are very difficult to handle, however, or by laminate structures which, however, require at least two different materials and also limit the design of the optical waveguide construction. In addition, coupling elements are required which couple the light from the light emitter into the optical waveguide and decouple it from the optical waveguide to the detection component. These coupling elements may be constructed e. g. as optical gratings, prisms or lens systems. The opto-electronic components (light emitters and light detectors) are externally coupled to the light-transmitting elements. In general, the design of such a sensor system is very time-consuming and costly, which does not make them ideally suitable for the production in large quantities. Moreover, they do not have a very compact design and thus cannot satisfy the general desire for integration and miniaturization in the field of sensor technology and the analytic sector.

### SUMMARY OF THE INVENTION

The object of the invention is to provide an optical sensor device of the type stated above, which can be realized in the form of a compact, integrated, stable constructional unit distinguished by a high degree of sturdiness and stability, nevertheless by a high degree of sensitivity and/or good response characteristics. Moreover, this sensor device should be susceptible to a miniaturized design. In particular, the present sensor device is to be applicable for a variety of purposes, such as in particular as touch (field) and/or switching means but also as bio- or chemosensor.

To achieve this object, the optical sensor device of the type stated above is characterized in that an optical layer of photopolymerizable material is applied on the substrate, in which the optical waveguide is structured by means of an exposure process, preferably a multi-photon absorption process, whereby the optical waveguide is led to the surface of the optical layer in the sensor region.

In the present sensor device, the optical waveguide is thus realized by an exposure process known per se, preferably the multi-photon absorption structuring technology known per se (normally two-photon absorption structuring, TPA-two photon absorption), wherein preferably the manufacture of a three-dimensional optical waveguide is made possible. “Three-dimensional” in this connection is understood to be both a possible course of the optical waveguide in x, y and z directions, i. e. a “spatial” course, as well as a design of the optical waveguide itself, concerning its cross-sectional shape, in any dimensions, so as to vary e.g. the cross-section from circular to elliptic or approximately rectangular, but also semi-circular etc. and vice versa. in particular, the described structuring also enables to split an optical waveguide generated by means of TPA structuring up into several branches and to subsequently re-combine these branches. Therefore, for obtaining a highly efficient sensor field, this structuring offers very special advantages since in the sensor field region the optical waveguide may have e.g. a broadened structure, a split-up structure, but also a wave-shaped curved structure with several curves adjoining the surface, or a flattened broad structure (e.g. with a semi-circular cross-section, with the flat side upwards). Thus, in the course of the structuring of the optical waveguide, an optimum sensor region can be obtained in a simple manner, in order to achieve the desired response sensitivity.

Furthermore, highly integrated and miniaturized sensor systems are rendered possible by the above structuring technology comprising “3D” optical waveguides.

For the compact design it is especially advantageous that the light source, the photodiode and, if applicable, the evaluating unit can be embedded in the optical layer. For many applications, in particular with respect to switching functions, the substrate may further simply be a circuit board substrate. The optical layer may be a glass-like organic-anorganic hybrid polymer, such as the hybrid polymer known by the designation of ORMOCER® which due to its glass-like properties as well as chemical stability is well-suited for a sensor field, such as a touch display or a sensor in aggressive media. Other suitable materials, for instance, are flexible materials such as polysiloxanes which likewise are very well-suited as waveguide material.

The optical layer can be elastically resilient at least in the sensor region.

Furthermore, it is conceivable to structure several optical waveguides, especially also crossing within the optical layer, whereby, if applicable, a matrix arrangement is provided to provide e.g. a touch panel or a keyboard. In the case of a transparent optical layer, markings can also be applied below the sensor fields, e.g. on the surface of the substrate and/or the circuit board layer, so as to display the respective sensor fields, such as tactile fields, in an adequate manner. A display can also be present below the optical layer, by means of which it would be possible to realize e.g. a touch screen.

Compared with the known optical sensors or switches, which are designed with specific light fibres, the latter having to be led to a touch surface in complicated windings, i.e. in general to the sensor region, resulting in a costly construction and a large amount of space required, the design according to the invention enables a very compact optical sensor device, such as a bio- or chemosensor, a light switch or the like, in which all relevant components, i.e. light source, optical waveguide and light sensor as well as, if applicable, evaluating unit, may be integrated in a thin optical layer. Moreover, the manufacture of the sensor device can be carried out in a fully automated manner, since both fitting the substrate with the components and the 3D-structuring of the optical waveguide with the help of the TPA method may well be subjected to a machine processing.

The present optical sensor device can be adapted for a variety of purposes. Thus, predefined chemical receptors reaching into the medium adjacent to the optical layer may be anchored e.g. to the surface of the optical waveguide, i.e. in the sensor region, where the optical waveguide is led to the surface of the optical layer. These receptors are provided or adapted to bind certain analytes to be detected. If in a specific case a certain analyte to be detected is present adjacent to the optical layer, said analyte will bind to the receptor intended for this, due to which the refractive index changes on the boundary of the optical layer to the surrounding area, to the medium, thus bringing about a change in the evanescent field and therefore the light intensity in the optical waveguide.

Another embodiment consists in that a medium comprising an analyte which is not transparent for all wavelengths of the transported light is provided at least above the portion of the optical waveguide which is led to the surface of the optical layer. If a specific analyte, such as ethanol, is present in the medium adjacent to the optical layer, which analyte is not transparent for the wavelengths or not for all wavelengths of the light transported in the optical waveguide, these special wavelengths are absorbed by the analyte via the dispersion in the evanescent field (in the region of the sensor field). Consequently, it is possible to determine the special analyte in this manner in terms of quality and/or quantity.

Finally, the present optical sensor device can be designed as an optical touch (field) device, in which the evanescent field adjacent to the sensor region (touch field) is disturbed upon the approach of an absorbing material, such as the membrane, of a sensor or a finger; the decrease of the light intensity in the optical waveguide caused thereby can now be detected, whereby the optical sensor device can be applied as sensor or switch.

As mentioned above, the optical sensor device can also be designed so as to comprise several sensor regions, i.e. “sensor portions” reacting independently from one another; in particular, these partial sensors can be obtained by crossing optical waveguides, so that a type of sensor matrix is formed. In the case of an optical sensor device, this can be used to realize a keyboard or a touch panel; in the case of a biosensor or chemosensor, a corresponding sensor array can also be provided thereby.

In the case of an optical layer which is transparent, as mentioned above, also sensor fields, in particular touch fields can be shown by markings provided underneath the optical layer, e.g. on the surface of the circuit board (the circuit board substrate). In particular, an image indicating device, a display might be present under the optical layer, so as to realize such a touch screen.

In the region of the integrated components, the optical layer may have a thickness of e.g. 200 μm or 300 μm, however, in those regions where only waveguides but no components are present, the layer thickness may be less, e.g. 100 μm or less to save material and/or increase the flexibility of the material. On the whole, a strong miniaturization can be achieved, which is of particular advantage for e.g. input units in electronics. Thus, for example, touch pads may be realized with great advantage in the field of mobile communications, in mobile phone devices.

Furthermore, the sensor device can be designed in a flexible and even transparent way, which leads to special design options. As the sensor device functions without current, special fields of application in highly sensitive regions where electromagnetic fields would disturb electric sensors will result, in which connection, however, they cannot influence the present optical sensor device. The sensor device could also be used in potentially explosive areas, since due to the current-less mode of operation no sparks can be produced. Any mechanical parts that are susceptible to wear are avoided, and the optical sensor device is thus practically maintenance-free.

As mentioned above, the invention has also a circuit board element with an optical sensor device as an object, whereby the substrate is a circuit board substrate or a circuit board layer, e.g. made of epoxy resin, possibly with glass fibre reinforcement. The circuit board substrate may also be flexible, such as a polyimide film, and it may be lying on e.g. a cylinder-shaped body not flat but also “curved”.

Furthermore, the invention relates to a method for the manufacture of an optical sensor device of this type, it being provided that on a substrate, for example, a circuit board layer, the at least one light source and the least one receiver, preferably also an evaluating unit are applied and potted in the photopolymerizable material of the optical layer, whereupon the at least one optical waveguide is structured in the optical layer by multi-photon absorption.

It is noted that structuring an optical waveguide in an optical layer by an exposure process is known as such, cf. e.g. U.S. Pat. No. 6,690,845 B1; in particular, structuring with the help of multi-photon absorption or two-photon absorption, respectively is known as such from AT 413891 B and AT 503585 A, it being further known to vary the focus for inscribing the optical waveguide in shape and size, so as to be able to realize a thinner or thicker waveguide. Furthermore, the position of the focal point may be varied in three dimensions, so as to inscribe the optical waveguide in the x, y and z directions. When applying this technology for the present optical sensor device, the electronic components may lie e.g. 100 μm or also 200 μm below the surface of the optical layer, depending on the design and on the layer thickness. In the sensor region, the optical waveguide is led directly to the surface, i.e. provided with a local “depth” of 0 μm under the surface, and such change of position of the optical waveguide in the z coordinate, i.e. in the depth, is only possible with the cited multi-photon absorption structuring. After structuring the optical layer is fixed. The cited prior art, however, does not deal with the option of leading optical waveguides to the material surface for the purpose of influencing the evanescent field of the guided light.

The evaluating unit evaluates the intensity of the transmitted light signals, and this evaluating unit may likewise be integrated in the optical layer. Without any disturbance of the evanescent field, e.g. by approaching with an object or touching, the evaluating unit determines a maximum signal intensity. If now the evanescent field of the light lying outside the optical waveguide will be disturbed, e.g. if an object, for example, a finger is moving towards the sensor field or is laid thereupon, this will lead to a decrease in intensity of the light guided in the optical waveguide. This decrease in intensity is registered by the evaluating unit, so that e.g. a “touch contact” or “switching desire” is detected.

### BRIEF DESCRIPTION OF THE DRAWINGS

The invention will be described in greater detail below by way of preferred exemplary embodiments in a non-limiting manner and on the basis of the drawings. The following is shown in detail in the drawing:

FIG. 1 shows a general schematic sectional view of an optical sensor device according to the invention.

FIGS. 2A and 2B show an optical sensor device according to the invention in the form of a touch pad device, having an enlarged sensor region as compared with FIG. i.e. in a schematic sectional view (FIG. 2A) and in top view (FIG. 2B);

FIG. 3 shows a schematic top view of another optical sensor device according to the invention;

FIG. 4 shows a schematic sectional view of still another sensor device, wherein an enlarged sensor region is shown and the electro-optical components are omitted;

FIGS. 5A and 5B show another sensor region of an optical sensor device according to the invention in longitudinal section (FIG. 5A) and cross-section (FIG. 5B), respectively.

FIGS. 6 and 7 show schematic sectional views of two further sensor devices according to the invention for (bio)chemical analyses; and

FIG. 8 schematically shows a top view of a portion of a matrix arrangement of sensor regions, e.g. for realizing a keyboard, a sensor array or a touch screen.

### DETAILED DESCRIPTION OF THE DRAWINGS

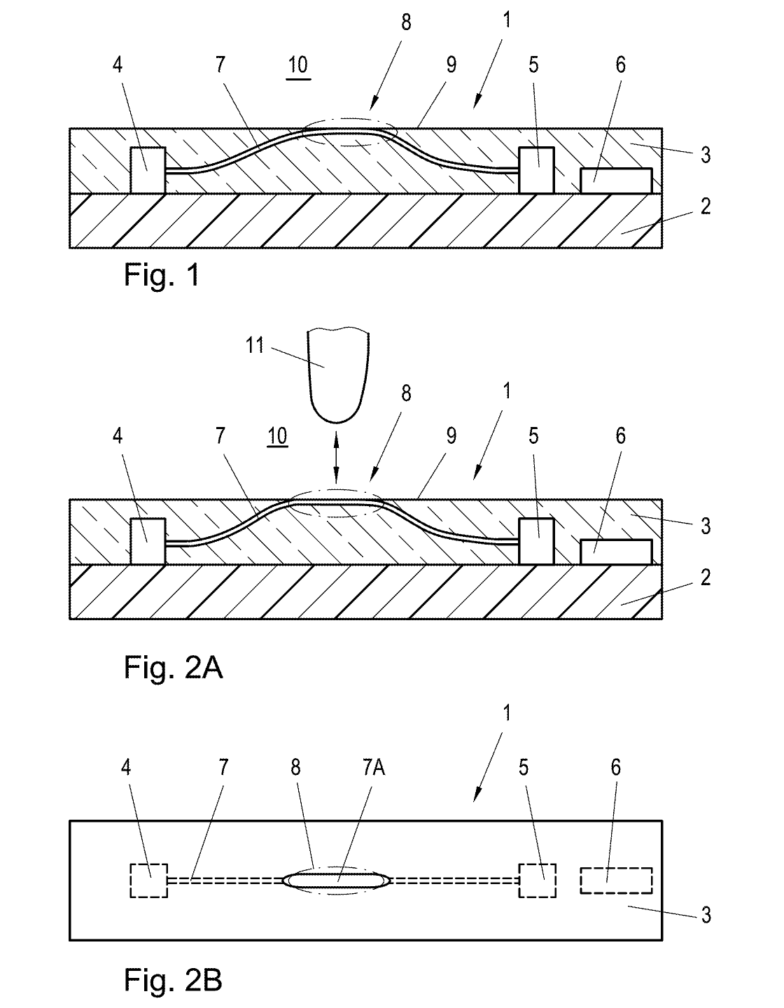

FIG. 1 schematically shows an optical sensor device 1 which comprises an optical layer 3 on a substrate 2, for example, a conventional circuit board layer. A light source 4, such as an LED, furthermore a light sensor or receiver 5, such as a photodiode, as well as an evaluating unit 6 are embedded in said optical layer 3. The evaluating unit 6 is connected to the receiver 5 by means of an electric connection, not illustrated in more detail, such as copper tracks on the substrate 2, so as to evaluate the output signals thereof which represent the light intensity of the light received. An optical waveguide 7 extends between the light emitter, i.e. the light source 4, and the light sensor, i.e. the receiver 5, which optical waveguide is structured in a manner known per se by a TPA process in the photopolymerizable material of the optical layer 3 in the desired manner, with the desired course and the desired cross-section. The optical waveguide 7 is led to the surface 9 of the optical layer 3 in a sensor region 8, such as an activating or touch field region, so that it extends directly along this surface 9 (or somewhat below) for a distance and thus defines a region sensitive for disturbances of the evanescent field of the optical waveguide 7. The optical waveguide 7 forms a first medium, and the surrounding area above the optical layer 3 forms a second medium 10, which may be gas or liquid.

If now in said sensor region 8 e.g. an object approaches the optical waveguide 7 or the object touches or presses on the surface 9 in the region 8, the evanescence field of the optical waveguide 7 spreading there will be disturbed, which will lead to a decrease in the intensity of the light transmitted in the optical waveguide 7. On the receiver 5, this will lead to a reduced electric current, which will be detected in the evaluating unit 6.

By using the optical layer 3 made of photopolymerizable material and preferably the TPA structuring technology, such as described in AT 413 891 B or AT 503 858 A, a compact constructional unit may be obtained for the sensor device 1, wherein the electro-optical components 4, 5, 6 are arranged on the substrate 2 and embedded in the optical layer 3. The optical waveguide 7 is directly integrated in this constructional unit by its structuring in the optical layer 3, so that in contrast to the prior art no separated component is required for this.

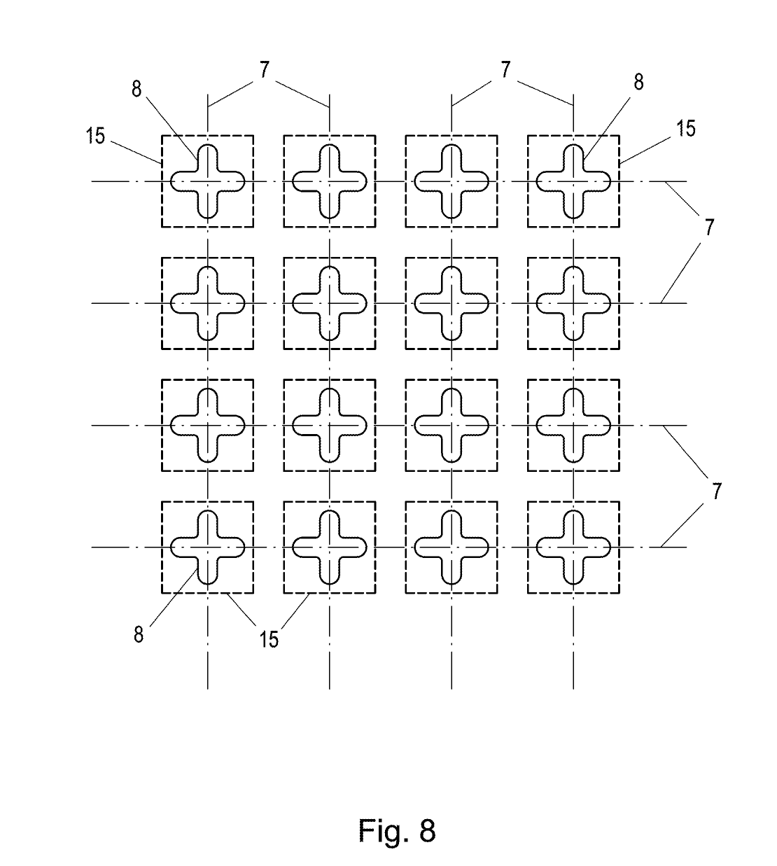

Depending on the design of the electro-optical components 4, 5 and 6 the thickness (height in FIG. 1) of the optical layer 3 may, depending on the design of the components 4, 5, 6, be e.g. only 100 μm or 200 μm, whereby nevertheless an exact optical wave-guiding from the light source 4 and to the sensor region 8 on the surface 9 and from there to the receiver 5 is possible. Thereby, an extremely efficient sensor device susceptible to miniaturization can be obtained, where it is also conceivable to realize the entire unit in a flexible design and/or realize it within a circuit board as a part thereof. In particular, it is also conceivable to provide several sensor regions 8, whereby a matrix can also be provided, so as to realize a touch panel or even a keyboard, as will be illustrated in more detail below with reference to FIG. 8. Below the optical layer 3, which may be transparent, the sensor regions 8 can be characterized also by marks visible to the eye, so as to allow deliberate touching of the regions 8. A display may also be present below the optical layer 3, so as to realize a touch screen with the help of several sensor or touch regions.

The manufacture of a sensor device 1 according to the invention, e.g. according to FIG. 1, may comprise the following steps:

Starting from the substrate 2, such as a conventional circuit board layer (epoxy resin) substrate, the light source 4, the receiver 5 and the evaluating unit 6 (which may be also present outside the constructional unit 1, however) are mounted preferably automatically; thereafter, these electro-optical or electronic components 4, 5, 6 are potted in the photopolymerizable material of the optical layer 3. Then, the optical waveguide 7 is “inscribed” between the light source 4 and the receiver 5 by means of the TPA technology, whereby in the sensor region 8 it is led to the surface 9 of the optical layer 3 (e.g. a boundary between the optical material and air). From this region 8, the optical waveguide 7 again extends within the optical layer 3 to the receiver 5, i.e. to its detection field. Depending on their design and depending on the layer thickness of the optical layer 3, the active surfaces of the opto-electronic components 4, 5 lie, for example, 20 μm to 200 μm below the surface 9 of the optical layer 3. In the sensor region 8, the optical waveguide 7, however, contacts the surface 9 directly, i.e. the boundary between the optical material and air, i.e. there is given a distance of 0 between the optical waveguide 7 and the surface 9 in this region 8; the optical waveguide 7 is at least brought very close to the surface 9; e.g. 0-10 μm thereunder. This change of position of the optical waveguide 7 in z direction (direction of height) can most simply be realized with the TPA process.

Finally, the photopolymerizable material of the optical layer 3 is fixed, so that a finished, e.g. flexible or rigid constructional unit is obtained.

As mentioned above, the intensity of the light signals is evaluated by the evaluating unit 6, so that in this manner analytes or touch and/or switch requests are detected, if the evanescent field of the optical waveguide 7 is influenced or disturbed, e.g. because an object, such as a finger, is approaching the optical waveguide 7 in the sensor region 8, in the medium 10 (as the case may be, there may be some contact).

A decrease of the intensity of the light guided in the optical waveguide 7, which is detected and evaluated, is effected by this disturbance of the evanescence field of the light outside the optical waveguide 7.

Of course, the light used is not restricted to the wavelength range of the visible light, but may also be in the UV or IR spectrum.

With respect to other details concerning methods and also usable materials, reference is made to the above documents AT 413 891 B and AT 503 858 A, whose contents with respect thereto are to be considered as being contained in the present description, so as to simplify the description.

FIGS. 2A and 2B show a schematic longitudinal section and a schematic top view, respectively, of a touch field device as a specific example of the sensor device 1, which essentially corresponds to the sensor device 1 according to FIG. 1, so that a repeated detailed description is not necessary. As shown in FIG. 2B, the optical waveguide 7 is designed with a broadened structure 7A in the sensor region, or touch region 8, respectively, so as to improve the response sensitivity of the formed feeler or switch. This broadened structure 7A may be obtained during the inscribing of the optical waveguide 7 by changing the focus correspondingly, however, it may also be obtained in that in this region the optical waveguide 7 is “inscribed” several times directly next to each other, if it is produced by the TPA technology.

When now, as is shown in FIG. 2A, in the second medium 10, an object 11, such as a finger, is moved toward the sensor or touch region 8 (and back again), this is detected by the evaluating unit 6 as a result of the change in the intensity of the light in the optical waveguide 7, via the receiver 5, as touch or switch command.

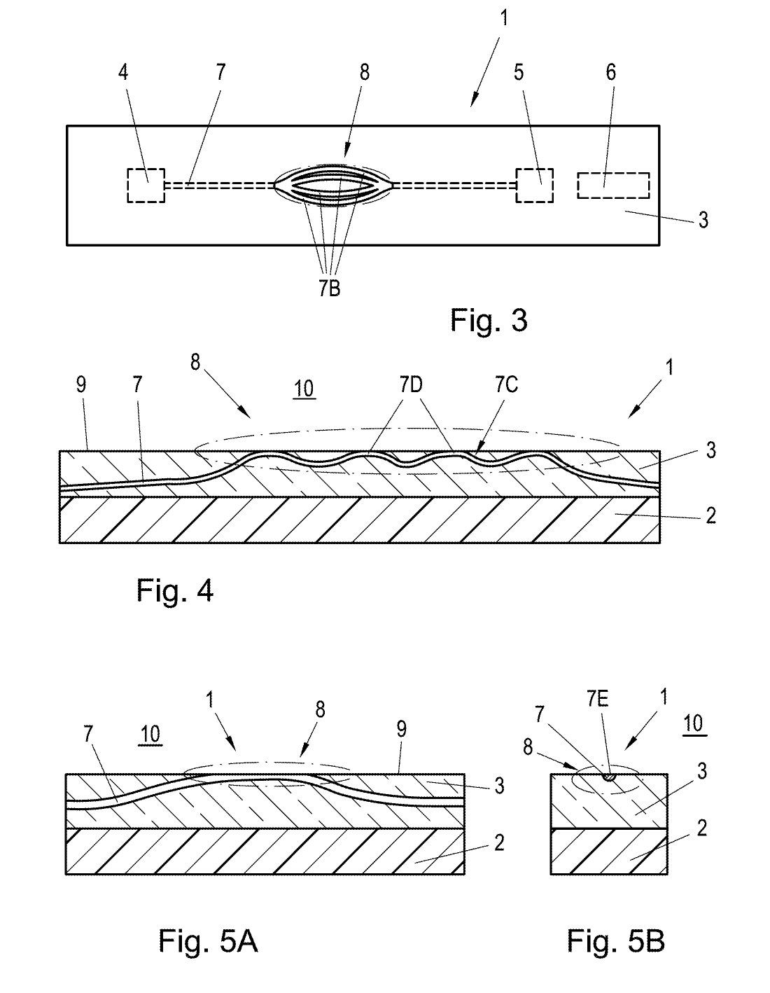

As compared to the embodiment according to FIG. 2B, FIG. 3 shows a modification insofar as in the touch region (sensor region) 8, the optical waveguide 7 is split up by producing several separate optical waveguide branches 7B, whereby, however, these optical waveguide branches 7B do directly not contact each other (which would lead to the broadened structure according to FIG. 2B).

According to the sectional view in FIG. 4, the embodiment of the optical waveguide 7 has a wave-shaped curved structure 7C in the sensor region 8, whereby several curves 7D adjoin the surface 9 of the optical layer 3. By this “wave geometry” of the optical waveguide 7 in the sensor region 8, a stronger evanescence field is produced in the zones with the smaller curve radius, so that the light weakening becomes also larger in the case of a disturbance of said evanescence field. Thus, in this embodiment, too, a high response sensitivity is possible.

In the embodiment according to FIGS. 5A and 5B, the optical waveguide 7 is “cut” in the region of the touch field 10 on the surface 9 of the optical layer 3, so that in the range of the sensor region 8 a flattened structure 7E is given for the optical waveguide 7, such as with a cross-section in a semi-circular shape or semi-elliptic shape, as can be seen in particular from FIG. 5B. This becomes possible in the course of the three-dimensional TPA structuring, whereby, during inscribing, the optical waveguide 7 is led to the surface 9 not only in a contacting manner (tangential) but is structured such that it lies only partially in the material of the optical layer 3; a portion of the focal region of the laser beam used for inscribing lies above the surface 9, i.e. outside the optical layer 3, so that only a partial cross-section instead of a full cross-section of the optical waveguide 7 is given in this region directly adjoining the surface 9. In this manner, the sensor or touch surface of the optical waveguide 7 is rendered larger on the surface 9 in region 8, however, the dimension of the optical waveguide 7 in z direction is rendered smaller.

By all these factors, the evanescence field in the surrounding medium 10 (i.e. e.g. air) is intensified, which in turn leads to an intensification of the optical signal change in the case of a disturbance of the evanescence field caused by an adjoining object 11 (FIG. 2A) or touching the optical layer 3 in the sensor region 8.

Such a “cut” optical waveguide 7 in the sensor region 8, as shown in FIG. 5, may likewise be manufactured by the TPA technology in an advantageous manner, as mentioned above; a comparable design, however, would not be conceivable with the known technology, with discrete components.

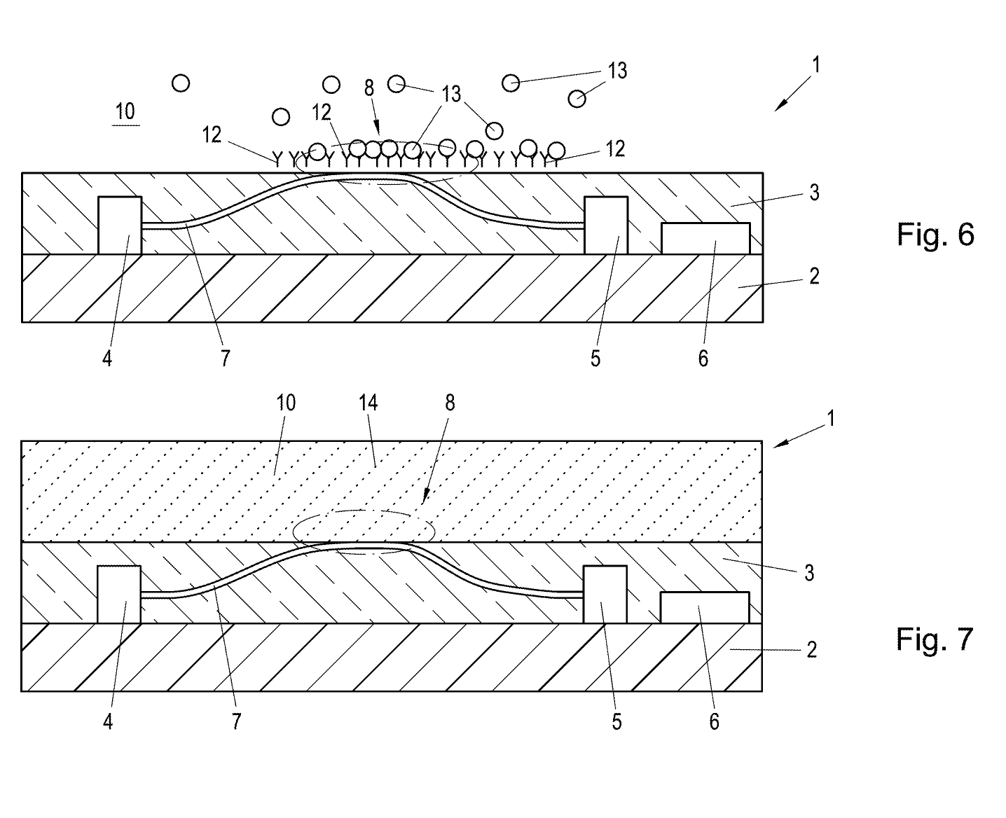

FIG. 6 shows an optical sensor device 1 which essentially corresponds to the embodiments according to FIG. 1 or FIG. 2 with respect to the application of the optical layer 3 on a substrate 2, the embedding of a light source 4, of a light receiver 5 and of an evaluating unit 6 in the optical material of the optical layer 3 as well as the TPA structuring of the optical waveguide 7 as well as its course in the sensor region 8 on or near the surface of the optical layer 3, so that this need not be described again. At least in the sensor region 8, predetermined receptors 12 are anchored to the surface of the optical layer 3, these receptors 12 reaching into the medium 10, which again can be e.g. a liquid or a gas. In FIG. 6, these receptors 12 are indicated only schematically, just like analytes 13 to be detected in the outer second medium 10. When now such an analyte 13 to be detected binds to a receptor 12, this changes the refractive index on the boundary between the optical waveguide 7, the first medium, to the second medium 10; this in turn leads to a change of the evanescent field and thus to a change of the light intensity in the optical waveguide 7 (first medium). This change of the light intensity in the optical waveguide 7 is in turn converted into an electric signal in the light receiver 5, which signal is evaluated in the evaluating unit 6 in order to indicate the respective analyte 13.

Of course, the optical waveguide 7 in the sensor region 8 may be designed in the embodiment according to FIG. 6 similar to FIG. 2B, FIG. 3, FIG. 4 or FIG. 5b, so as to obtain a sensor region 8 as effective as possible, and, of course, this also applies to other embodiments, such as the embodiment of the optical sensor device 1 according to the invention and to be described on the basis of FIG. 7, by means of which certain analytes to be detected can be detected directly on the basis of the their optical properties.

In detail, the optical sensor device 1 according to FIG. 7 is designed in the same manner as the above described sensor devices 1 according to FIGS. 1, 2A, 6 (but also FIG. 3 and FIG. 5), so that it need not be described one more time.

Again, an outer, second medium 10 is present above the optical layer 3, whereby the optical waveguide 7 in the sensor region 8 defines a first medium. In the outer medium 10 there is contained e.g. an analyte 14, such as ethanol, which is not transparent for all wavelengths of the light transported in the optical waveguide 7. According to this, these special wavelengths are absorbed by the analyte 14 via the dispersion in the evanescent field, in the sensor region 8. The intensity of the light in the optical waveguide is in turn changed thereby, i.e. selectively for the certain wavelengths. Consequently, it is thus possible to determine the special analyte 14 in terms of quality and/or quantity.

Thus, in general, it applies to all embodiments described so far that in the present, highly integrated optical sensor device 1, the optical waveguide 7 is led as first medium in a sensor region 8 close to the surface 9 or directly to this surface 9 of the optical layer 3, so that it adjoins a further, second, outer medium 10. Changing optical parameters of the outer, second medium 10, which change, e.g. weaken the evanescent field of the light guided in the optical waveguide 7, also involves a change of intensity (e.g. weakening) of the light guided in the optical waveguide 7; this change of intensity can be detected and evaluated by means of components 5, 6.

The optical sensor device 1 may be extremely compact, where all relevant components (light source 4, waveguide 7, light receiver 5, possibly evaluating unit 6) can be integrated in a thin optical layer 3. The manufacture of the sensor device I can be carried out in a fully automated manner, since both inserting the components 4, 5, 6 as well as the 3D structuring of the optical waveguide 7 are very well suited to machine processing.

Due to the fact that the optical layer 3 is e.g. only a few hundred μm thick (if at all), a highly miniaturized design of an optical sensor device 1 can be obtained, which is suited for various sensor applications, such as shown above with reference to FIGS. 6 and 7, or as input units in electronics applications. The described bio- or chemosensors may be used in environmental analysis, in the food industry, in human and veterinary diagnostics and in plant protection to determine analytes in terms of quantity and/or quality. On the other hand, miniaturized sensor devices in the form of switching or touch field devices are of high interest in particular also in the field of mobile phone applications.

Consequently, it is possible to provide in a matrix arrangement individual sensor or touch regions 8 which are formed where optical waveguides 7 arranged in lines and columns are crossing, as schematically indicated in FIG. 8. Said FIG. 8 shows only quite schematically a top view of optical waveguides 7 indicated by simple lines as well as matrix-like arranged sensor regions 8, whereby the optical waveguides 7 crossing in these sensor regions 8 are led to the surface of the optical layer 3 (in FIG. 8 not shown) in a similar manner as shown in FIG. 1, FIG. 2A etc.; in the intermediate regions they are present at a distance from the surface 9 (cf. FIG. I) of the optical layer 3, so that no influencing of evanescent fields is possible there. Below these sensor regions 8 which may be e.g. cross-shaped to round when viewed in a top view, for instance on the upper surface of the substrate 2 (FIG. 1), marks 15 or quite generally representations or displays and/or image reproducing elements may be provided, so as to realize e.g. a keyboard or a similar touch pad, and, if desired, also a type of touch screen.

In connection with the matrix arrangement of the sensor regions, or touch or switching regions 8, respectively, according to FIG. 8, it should be obvious that the individual optical waveguides 7 must be distinguishable from one another in terms of their light signals, both in the lines and in the columns, so as to be able to identify the respective “switching point” or “touch point”, i.e. the respective sensor region 8 that was activated according to its coordinates (line/column). For this purpose, for example, the output ends of the optical waveguides can be led to various light receivers 5 or at least to various detector regions of light receivers 5, in accordance with both the lines and the columns, so that they can be clearly identified in the area of the light receiver 5. In this case, the optical waveguides 7 may also be coupled on the input side to a common light emitter 4, if desired, space conditions permitting, even to all optical waveguides 7 of all lines and columns. Suitably, however, the optical waveguides 7 of all lines are coupled to a light emitter and the optical waveguides 7 of all columns to another light emitter. In addition, it is also conceivable to provide an own light source for each optical waveguide 7, at least for each one of the column optical waveguides and for each one of the line optical waveguides, having a wavelength predetermined for the respective optical waveguide 7, whereby the respective optical waveguide can be clearly identified on the detector side (light receiver 5) on the basis of the respective wavelength or frequency, so as to recognize the respective matrix point.

As mentioned above, the present sensor device 1 may be designed in a rigid, but also in a flexible and, if desired, also a transparent manner, which leads to new application and design possibilities. It is also of advantage that the present optical sensor device works without current, as mentioned already, so that special application possibilities in highly sensitive areas will result, where electromagnetic fields would disturb electric constructions. The present optical sensor device I can also be used in potentially explosive environments, as it cannot produce sparks due to its current-less functionality. As the present sensor device 1 does not require any mechanically movable parts, it is not subject to wear either and is practically maintenance-free.

Although the invention is illustrated above in more detail on the basis of preferred embodiments, however, it goes without saying that other variations and/or modifications are possible. Thus, for instance, in the sensor region 8 also a generally rectangular cross-section of the optical waveguide 7 is conceivable, and it is also possible to combine such broadened structures of the optical waveguide 7, also such as shown in FIGS. 2B and 3 and/or 5B, e.g. with the waveform according to FIG. 4.

1. An optical sensor device (1) comprising a substrate (2) on which at least one light source (4), such as an LED, is arranged, from which at least one optical waveguide (7) leads to at least one receiver (5), such as a photodiode, the optical waveguide (7) being accessible in a sensor region (8) for a change of its evanescence field present there, characterized in that an optical layer (3) made of material that can be photopolymerized is placed on the substrate (2), in which layer the optical waveguide (7) is structured by an exposure process, the optical waveguide (7) being led to the surface (9) of the sensor region (8).

2. The sensor device according to claim 1, characterized in that the optical waveguide (7) is structured in the optical layer (3) by a multi-photon absorption process.

3. The sensor device according to claim 1, characterized in that an evaluating unit (6) connected to the receiver (5) is embedded in the optical layer (3).

4. The sensor device according to claim 1, characterized in that the light source (4) is embedded in the optical layer (3).

5. The sensor device according to claim 1, characterized in that the receiver is embedded in the optical layer (3).

6. The sensor device according to claim 1, characterized in that the optical waveguide (7) comprises a widened structure (7A) in the sensor region (8).

7. The sensor device according to claim 1, characterized in that the optical waveguide (7) comprises a split-up structure in the sensor region (8), said split-up structure comprising several waveguide branches (7B).

8. The sensor device according to claim 1, characterized in that the optical waveguide (7) comprises a wave-shaped curved structure (7C) in the sensor region (8), said curved structure comprising several curves (7D) adjoining the surface.

9. The sensor device according to claim 1, characterized in that the optical waveguide (7) comprises a flattened structure (7E) in the sensor region (8), for example, a structure with a semi-circular cross-section.

10. The sensor device according to claim 1, characterized in that the optical layer (3) comprises a glass-like organic-anorganic hybrid polymer.

11. The sensor device according to claim 1, characterized in that the optical layer (3) is elastically resilient at least in the sensor region (8).

12. The sensor device according to claim 1, characterized in that several, possibly crossing optical waveguides (7) are structured in the optical layer (3), possibly by forming a matrix arrangement of sensor regions (8).

13. The sensor device according to claim 1, characterized in that a mark or a display is provided below the sensor region or the sensor regions (8).

14. The sensor device according to claim 1, characterized in that specified receptors (12) are anchored to the surface of the optical waveguide (7) in the sensor region (8), which receptors are adapted to bind an analyte (13) to be detected.

15. The sensor device according to claim 1, characterized in that at least above that portion of the optical waveguide (7) which is led to the surface (9) of the optical layer (3), there is provided a medium comprising an analyte (14) which is not transparent for all wavelengths of the transported light.

16. The sensor device according to claim 1, characterized in that the sensor region (8) forms a touch pad region changing the light intensity in the optical waveguide (7) upon an approach of an absorbing medium (11), such as a finger or a touch membrane.

17. A circuit board element comprising an optical sensor device according to claim 1, wherein the substrate (2) is a circuit board substrate.

18. A method of manufacturing an optical sensor device (1) according to claim 1, characterized in that on a substrate (2), for example, a circuit board layer, the at least one light source (4) and the at least one receiver (5), preferably also an evaluating unit (6), are applied and potted in the photopolymerizable material of the optical layer (3), whereupon the at least one optical waveguide (7) is structured in the optical layer (3) by an exposure process, preferably by multi-photon absorption.
